(19) United States
(12) Patent Application Publication
(10) Pub. No.: US 2026/0332506 A1
(43) Pub. Date: Oct. 22, 2026

(54) TRAFFIC MONITORING IN A TELECOMMUNICATIONS NETWORK

(71) Applicant: Telecom Italia S.p.A., Milano (IT)

(72) Inventors: Marco Areddu, Torino (IT); Paolo Cassala, Torino (IT); Cornelio Pisa, Torino (IT); Michele Rizzoli, Torino (IT)

(21) Appl. No.: 19/119,048

(22) PCT Filed: Oct. 6, 2023
(86) PCT No.: PCT/EP2023/077767

§ 371 Date: Apr. 7, 2025

(30) Foreign Application Priority Data
Oct. 10, 2022 (IT) 102022000020823

(51) Int. Cl. H04L 43/16; H04L 43/067; H04L 43/0882; H04L 43/0888

(52) U.S. Cl. CPC H04L 43/16; H04L 43/067; H04L 43/0882; H04L 43/0888

(57) ABSTRACT

It is disclosed a method for monitoring a data traffic in a telecommunications network, the data traffic being associated with a service providing a multimedia content associated with a target event to users via at least one network node. The method comprises applying a monitoring profile to monitor the data traffic in a target period subdivided into discrete recording intervals. The monitoring profile comprises thresholds to be applied to process a performance indicator. The method comprises, at each recording interval: collecting measurements of the performance indicator provided by the at least one network node, computing a differential value of the performance indicator as a difference between a current measurement and a measurement provided at a previous recording interval, comparing the differential value with one or more respective thresholds and, if the differential value does not comply with the one or more thresholds, detect an anomaly.

### TECHNICAL FIELD

The present invention relates to the field of telecommunications networks. In particular, the present invention relates to the field of monitoring a data traffic in a telecommunications network. Moreover, the present invention relates to managing the telecommunications network on the basis of the data traffic monitoring.

### BACKGROUND ART

As known, monitoring the data traffic for a telecommunications service provider (simply, service provider) is essential to track the behaviour of the network and detect possible failures causing inefficiencies, delays, and so on. Monitoring the data traffic related to a provisioned service, such as, for example, a streaming media service (in particular, a video streaming service providing multimedia contents to service subscribers) is even more important when the telecommunications network has to face an unexpected fluctuation of the data traffic due to a statistically exceptional event, whose associated multimedia content attracts a large number of subscribers.

A statistically exceptional event is a non-repetitive event. Examples of such events, when considering a video streaming service, are sport events, such as a football game, a stage of a cycling race, an Olympic competition, a tennis match, etc.; entertainment events such as a concert, etc.; massive social events such as a speech from a head of state, a parade, etc.

In these cases, indeed, it is crucial that the network traffic, which may be highly variable before, during and after the considered event, is accurately monitored to track how the telecommunications network is handling the provisioned service and detect possible failures of the network leading to a poor quality of service and then to a poor quality of experience (or even to an interruption of the service) perceived by the service subscribers.

US 2011/0085649 A1 discloses a fluctuation monitoring method based on the mid-layer data comprising a monitoring component of the customized instance, mid-layer telephone traffic statistics, a component of self learning telephone traffic and a drawing component of multidimensional traffic monitor. 1) Modeling of telephone traffic status is based on social science empirical model, and uses telephone traffic per day as an analysis granularity, which is composed of three dimensions-time, region and business. 2) the mid-layer of the telephone traffic statistics is calculated based on a monitoring target in regular time. 3) the self learning component of telephone traffic studies and forecasts based on monitoring data. 4) the drawing component of multidimensional traffic monitor will extract data from in the mid-layer of traffic data statistics.

### SUMMARY OF THE INVENTION

The inventors noticed that state-of-the-art methods for monitoring the data traffic in a telecommunications network are typically based on static data traffic models (also indicated as patterns or profiles). If a deviation is detected between the actual data traffic and the expected data traffic as defined according to a static data traffic profile, an alarm is raised so that an intervention may be scheduled to investigate whether a failure is affecting the telecommunications network and causing the detected deviation, and finally to manage it. Static data traffic profiles are typically determined based on statistical data which may be collected on a daily basis and gathered to form historic series of data traffic representing the expected behaviour of the network.

However, as noted by the inventors, such static data traffic profiles do not allow to effectively monitor the data traffic on a service basis, especially for services, such as streaming media services, which may be associated to fluctuations in the related data traffic due to occurrence of statistically exceptional events. Indeed, for a streaming media service, when a statistically exceptional event occurs, the traffic fluctuations associated with such an event cannot be predicted by any static data traffic profile. In principle, if a static data traffic profile is applied to monitor the data traffic during a statistically exceptional event, the data traffic is likely to deviate from the expected behaviour for most of the time of the exceptional event. However, this may not be indicative of a real failure of the telecommunications network as the static data traffic profile certainly does not provide any modelling of the network behaviour in such a scenario.

In view of the above, the Applicant has tackled the problem of providing a method for monitoring a data traffic in a telecommunications network which allows overcoming the drawbacks outlined above. In particular, the Applicant has tackled the problem of providing a method for monitoring a data traffic associated with a given service in a telecommunications network, such as a streaming media service, which allows to effectively monitor the data traffic on a service basis when a statistically exceptional event occurs and causes unexpected data traffic fluctuations. An effective monitoring indeed allows to detect possible failures potentially causing a degradation in the quality of service and then in the quality of experience perceived by the users (this term including the subscribers) of the provisioned service. It follows that such an effective monitoring allows managing the telecommunications network to react to the detected failure or degradation.

In the present description and in the claims, the expression “statistically exceptional event” or simply “exceptional event” or “target event” refers to a non-repetitive event associated with a unique audio-video content provided by a service (for instance, a streaming media service) provisioned over a telecommunications network, either a fixed telecommunications network or a mobile telecommunications network, to a number of users and accessible by any of these users by means of a fixed or mobile multimedia equipment connected to the telecommunications network (such as a PC, a smartphone, a tablet, a smart TV or the like). Moreover, a “statistically exceptional event” or “exceptional event” or “target event” is an event having a limited duration in time which could attract a user to operate her/his multimedia equipment for a period of time of a limited duration, which period of time is correlated to the duration of such event.

Finally, the expressions “measurement of a performance indicator” and “value of a performance indicator” will be used interchangeably. According to a first aspect, the present invention provides a method for monitoring a data traffic in a telecommunications network, the data traffic being associated with a service providing a multimedia content to users via at least one network node, the multimedia content being associated with a target event, the method comprising applying a monitoring profile to monitor the data traffic in a target period comprising the target event, the target period being subdivided into discrete recording intervals, the monitoring profile comprising a set of thresholds to be applied to process measurements of a performance indicator at the recording intervals, wherein applying the monitoring profile comprises, at each of the recording intervals:
a) collecting measurements of the performance indicator provided by the at least one network node;
b) computing a differential value of the performance indicator as a difference between a current measurement of the performance indicator measured at the recording interval and a previous measurement of the performance indicator measured at a previous recording interval;
c) comparing the differential value with one or more respective thresholds of the set of thresholds; and
d) if the differential value does not comply with the one or more thresholds, detecting an anomaly in the data traffic.

Preferably, the monitoring profile is associated with a class of events to which the target event belongs.

Preferably, the method further comprises determining the monitoring profile on the basis of a data traffic forecast for the data traffic associated with the class of events.

Preferably, determining the monitoring profile further comprises subdividing the target period into a number of target subperiods, wherein each of the target subperiods comprises a respective number of recording intervals and each target subperiod is associated with a respective specific trend in the measurements of the performance indicator, the specific trends being identified according to the data traffic forecast.

Preferably, each target subperiod is selected as a time interval during which the data traffic is expected to grow or to remain substantially stable or to decrease.

Preferably, the monitoring profile is defined as follows:
for each recording interval RI(i), where i=1, . . . , N, i being an integer number counting the recording intervals within the target period:
   if the recording interval belongs to a target subperiod where the data traffic is expected to grow, set a threshold, Tg, higher than zero and check whether the differential value is higher than said threshold, Tg;
   if the recording interval belongs to a target subperiod where the data traffic is expected to remain substantially stable, set a first threshold, Ts1, higher than zero and a second threshold, Ts2, lower than zero, and check whether the differential value is lower than the first threshold, Ts1, in case the differential value is higher than zero, and whether the differential value is higher than the second threshold, Ts2, in case the differential value is lower than zero;
   if the recording interval belongs to a target subperiod where the data traffic is expected to decrease, set a further threshold, Td, lower than zero and check whether the differential value is higher than the further threshold, Td.

Preferably, the monitoring profile is stored in a database as associated with the class of events.

Preferably, the method further comprises scheduling the target event in a calendar at a given date and time of the day and adding to the calendar an instance of the monitoring profile at the given date and time of the day to monitor the data traffic associated with the target event according to the monitoring profile.

Preferably, the performance indicator is one of the following: an amount of downlink or uplink data traffic associated with the service handled by the at least one network node, an amount of downlink or uplink data traffic associated with the service handled by one of the at least one network node, a data traffic throughput associated with the service, a ratio between a downlink or uplink data traffic for the service and an overall downlink or uplink data traffic handled by one of the at least one network node.

Preferably, the service is a streaming media service.

According to a second aspect, the present invention provides a method for managing a telecommunications network, the method comprising:
monitoring a data traffic in the telecommunications network according to the method set forth above, the data traffic being associated with a service providing a multimedia content to users via at least one network node of the telecommunications network, the multimedia content being associated with a target event, and
managing network resources of the telecommunications network to react to the detected anomaly.

According to a third aspect, the present invention provides a control system for monitoring a data traffic in a telecommunications network, the data traffic being associated with a service providing a multimedia content to users via at least one network node, the multimedia content being associated with a target event, the control system being configured to apply a monitoring profile to monitor the data traffic in a target period comprising the target event, the target period being subdivided into discrete recording intervals, the monitoring profile comprising a set of thresholds to be applied to process measurements of a performance indicator at the recording intervals, wherein the control system is further configured to, at each of the recording intervals:
collect measurements of the performance indicator provided by the at least one network node;
compute a differential value of the performance indicator (KPI) as a difference between a current measurement of the performance indicator measured at the recording interval and a previous measurement of the performance indicator measured at a previous recording interval;
compare the differential value with one or more respective thresholds of the set of thresholds; and
if the differential value does not comply with the one or more thresholds, detect an anomaly in the data traffic

According to a fourth aspect, the present invention provides a telecommunications network comprising at least one network node and a control system as set forth above.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows an exemplary telecommunications network to which the method of the present invention may be applied;

FIG. 2 schematically shows a graph representing exemplary values of a performance indicator for the data traffic of a considered service associated with a target event; and

FIG. 3 is a flowchart illustrating steps of the method of the present invention.

### DETAILED DESCRIPTION OF PREFERRED EMBODIMENTS OF THE INVENTION

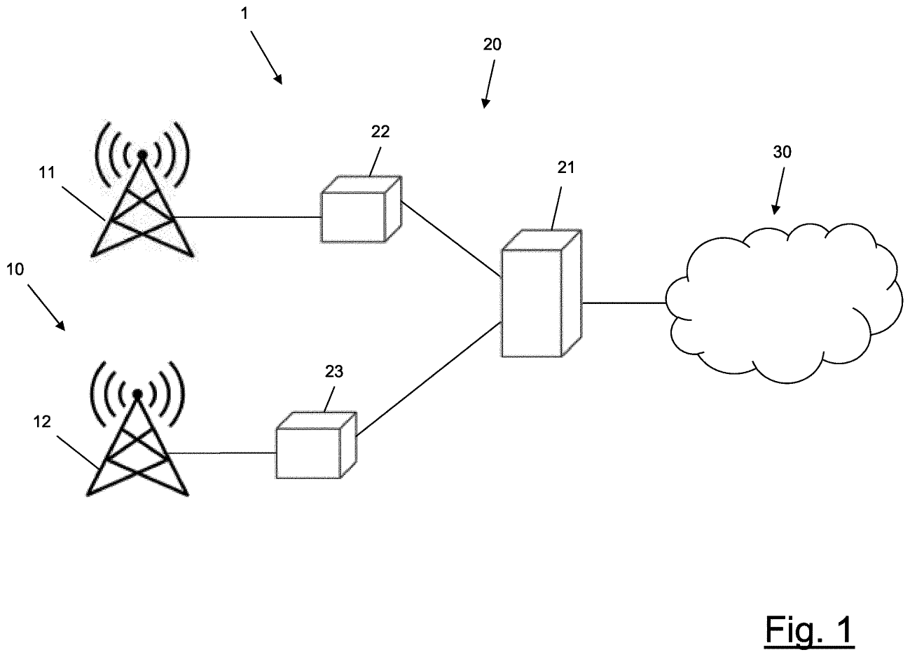

FIG. 1 schematically shows an exemplary packet-switched telecommunications network 1 connecting users to the Internet for the provisioning of services to their user's equipment. The network 1 of FIG. 1 comprises a radio access network 10, a core network 20, and an external data network 30, namely the Internet. The radio access network 20 comprises a number of base stations 11, 12 (two base stations in the exemplary network of FIG. 1) configured to connect a number of user's devices to the core network 20, which connects the radio access network 10 to the external data network 30. The core network 20 comprises a number of network nodes 21, 22, 23 (three nodes in the exemplary network of FIG. 1).

It will be assumed, for sake of non-limiting example, that the network schematically represented in FIG. 1 is an LTE (Long Term Evolution) network. In this scenario, the radio access network 10 may be, as known, an E-UTRAN comprising a number of eNodeBs 11, 12 while the core network 20 may be an Evolved Packet Core (EPC) network. The exemplary EPC network 20 as represented in FIG. 1 may comprise a Packet Data Gateway (P-GW) 21, and two serving gateways (S-GW) 22, 23. The packet data gateway 21 is configured to route the data traffic between the serving gateways 22, 23 and the Internet, while each serving gateway 22, 23 is configured to forward user's data traffic between the eNodeB 11, 12 associated with the user and the packet data gateway 21. As known, an LTE network comprises other types of network nodes. However, a detailed description of the LTE network architecture is not relevant to the present description. Hence, further detail on such an architecture and on how the network nodes operate to manage the data traffic between the user's equipment and the Internet will be omitted.

The telecommunications network 1 is used by a telecommunications service provider to provide services to service users via the Internet. Examples of such services are streaming media services (such as video streaming services) carrying live and on-demand streaming of events (e.g., Netflix, Amazon Prime Video, Disney+, YouTube, DAZN, etc.). According to the scenario of application of the present invention, the considered service is providing multimedia (namely, audio-video) contents which may be associated with one or more statistically exceptional, or target, events. Target events within the meaning of the present invention may be classified according to one or more classes of events comprising sport events, entertainment events, social events, etc. Classes of events may also be defined at a level of finer granularity. For instance, for sport events, classes of events may be the following: football matches, tennis matches, cycling races, Olympic competitions, and so on. According to the present invention, each class of events may be associated with a monitoring profile to be applied to monitor the data traffic associated with target events of the considered class of events, as it will be described herein after.

The telecommunications network 1 comprises a control system (not shown in the drawings) configured to monitor the data traffic according to the present invention. The control system may be, according to a preferred embodiment of the present invention, a software-implemented system which may be installed on one or more servers of the telecommunications network 1 managed by the service provider. The control system may also be accessed from an equipment handled by an operator (e.g., a PC connected to the server(s) via the Internet) so that the operator may interact with the system to input data and commands and to receive system's outputs in the form of, for instance, control messages or alarm messages. The control system may be configured to cooperate with one or more databases. Moreover, the control system preferably comprises a calendar of operation of the control system, to schedule the operation of the data traffic monitoring according to the method of the present invention, as it will be described in greater detail herein after.

The control system may be part of or configured to cooperate with any of the following network systems:
a network configuration management system in charge of collecting and maintaining configuration data of the network apparatuses, and to track changes on the apparatuses' configuration;
a network performance management system in charge of gathering information on network performance (throughput, delay, packet loss rate, etc.) and alert administrators when performance goes below a predefined threshold; and
a fault management system in charge of gathering information related to detected failures in the telecommunications network and take appropriate actions when an alarm is raised.

The systems listed herein above, and their operation, are known to a person skilled in the art. In any case, a detailed description of such system is not relevant to the present invention and hence will be omitted.

According to the present invention, the control system is configured to implement steps of a method for monitoring the data traffic associated with a given service, the data traffic being carried by the core network 20 of the telecommunications network 1. For each monitored service, the data traffic monitoring is based on measurements of one or more respective performance indicators which are provided by the network nodes 21, 22, 23 of the core network 20. In particular, in an evolved packet core network 20, the measurements of the performance indicators are preferably provided by the packet data gateways 21. More in general, the method of the present invention may be applied to monitor the data traffic associated with a given service which is handled by a single network node or to monitor the data traffic for the given service which is handled by a number of network nodes of the considered network.

According to the present invention, the performance indicators are metrics related to the network performance and are measured by the network nodes 21, 22, 23 of the core network 20. The performance indicators may comprise absolute performance indicators related to absolute quantities such as an amount of data traffic handled by a single network node or by a number of network nodes for the given service, an amount of downlink or uplink data traffic handled by a single network node or by a number of network nodes for the given service, a data traffic throughout associated with a given service, and so on. Moreover, the performance indicators may also comprise relative performance indicators, each associated with a ratio between quantities such as a ratio between the amount of downlink or uplink data traffic at a given network node for a given service and the overall downlink or uplink data traffic of the considered network node, a ratio between the data traffic throughput at a given network node for a given service and the overall data traffic throughput of the considered network node, and so on. In particular, the performance indicators may comprise an amount (measured in GigaB) of data traffic associated with a given service handled by a specific network node in uplink direction or downlink direction and a ratio (measured as a percentage value) between the downlink or uplink data traffic for the given service and the overall downlink or uplink data traffic handled by the network node.

The performance indicators described herein above are related to data traffic actually handled by the telecommunications network. Other performance indicators may be related to a data traffic which is offered in the telecommunications network (which represents a data traffic which the telecommunications network may only possibly handle), or to other parameters such as, for instance, calls or sessions offered, BHCA or Busy-hour-call-attempts, etc.

For a given service, the choice of the performance indicator(s) to be considered according to the method of the present invention may be based on the availability of previous data or a data history related to the considered service. For a streaming media service providing the subscribers with live events such as football matches of a given championship, the choice of the performance indicator(s) may be based on the data history of the football matches that were played during the previous championship. In that case, indeed, the data relating to the amount of data traffic or the throughput that has been handled by the network nodes for the matches of the previous championship are available and may provide indications about expected amounts of data for the matches of the current championship; therefore, absolute performance indicators may be used. On the contrary, if no data history is available, relative performance indicators may be used. Hence, relative performance indicators are useful to monitor the data traffic related to new services for which no previous information is available, or to monitor the data traffic related to unique, localized events associated with, for example, social dynamics (e.g., a concert), natural events, etc.

According to the present invention, the measurements of each performance indicator are collected at discrete time intervals during operation of the control system. These time intervals will be indicated as recording intervals RI. Each recording interval RI may have a duration of 15 minutes.

The control system is configured to implement a method for monitoring the data traffic carried by the given service during a predefined observation period OP comprising a target event of a given duration (which will be related to a target period, TP). The observation period OP is subdivided in a number N of recording intervals RI, where N is an integer number higher than 1.

For the data traffic monitoring during a target event of a given class of events, the method provides for applying a class-related monitoring profile to data derived from the measurements of the considered one or more performance indicators. The monitoring profile preferably comprises a respective set comprising one or more thresholds for each performance indicator for monitoring a target event of the considered class of events. Applying the monitoring profile comprises comparing the data derived from the measurements of each considered performance indicator with the respective set of thresholds and determining deviations of the data with respect to said thresholds in order to report an alarm if a deviation is detected. The threshold(s) to be applied to a performance indicator may vary, within the related set of thresholds, on a recording interval basis or over longer intervals comprising a number of recording intervals each. In other words, when the control system applies the monitoring profile for monitoring the data traffic associated with the target event, each recording interval is preferably associated with a subset of corresponding thresholds of the set of thresholds associated with the considered performance indicator. Then, if the differential value of the performance indicator in the recording interval deviates from said set of corresponding thresholds, the control system issues an alarm. The situation in which a deviation is detected is indicated also as “an anomaly in the data traffic” or simply “an anomaly”. The alarm associated with the detected anomaly in the data traffic will be handled by the performance management system and/or the fault management system of the telecommunications network.

Exemplary management actions that may be performed after the detection of an anomaly according to the present invention involve managing the network resources (e.g., nodes, apparatuses, channels, links, etc.) of the telecommunications network to react to the detected anomaly. These management actions may comprise at least one of the following:
increasing of processing and/or transmission capacity by activating new network resources;
redistributing traffic among the network resources currently available;
limiting access to network resources in case there is a risk of compromising the stability of the network; and
any combination of the above actions.

According to the present invention, the data traffic monitoring is advantageously dynamic as it applies, when a given target event occurs, a monitoring profile tailored on the target event, which allows monitoring the data traffic associated with the given target event in nearly real-time. Indeed, as explained above, the method provides and applies, for each considered performance indicator, a respective set of one or more thresholds and the applied thresholds are time-varying (namely, they may vary on a recording interval basis or over longer intervals comprising a number of recording intervals each) to follow the trend of the data traffic within the observation time period, which comprises the duration of the target event.

In particular, the control system of the present invention is preferably configured to operate by collecting the measurements of each considered performance indicator at the end of each recording interval RI mentioned above. At the end of each recording interval RI, the control system computes a differential value of each performance indicator as a difference between the measurement of the performance indicator at the end of the current recording interval RI and the measurement of the same performance indicator at the end of a previous recording interval RI.

The choice of computing differential values to monitor the data traffic of the target event of a given class is based on the observation that, for events of the same class (e.g., football matches), the measurements of a given performance indicator during the event may show different absolute values from event to event, as each event is unique per se, but the differential values may closely indicate the data traffic fluctuations that may have similar trends during this kind of events.

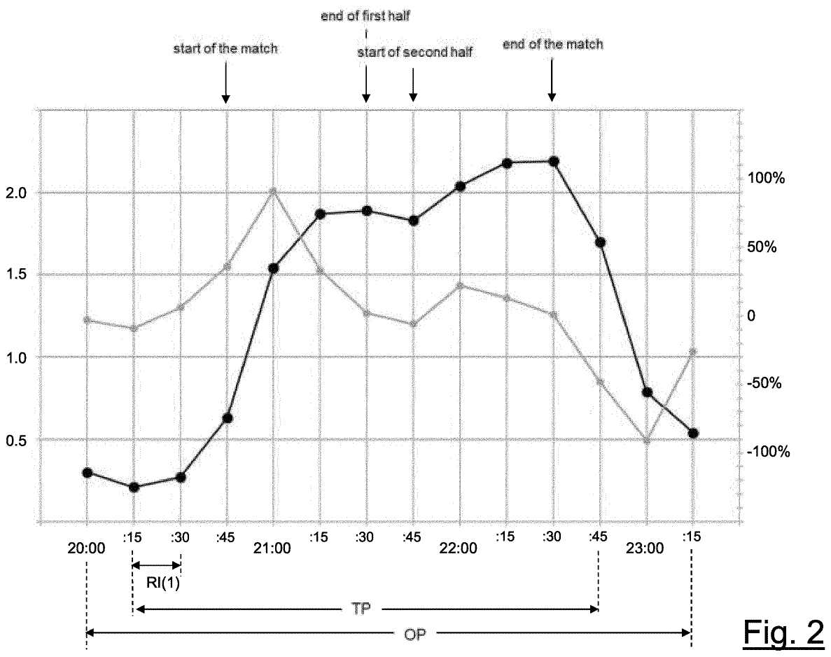

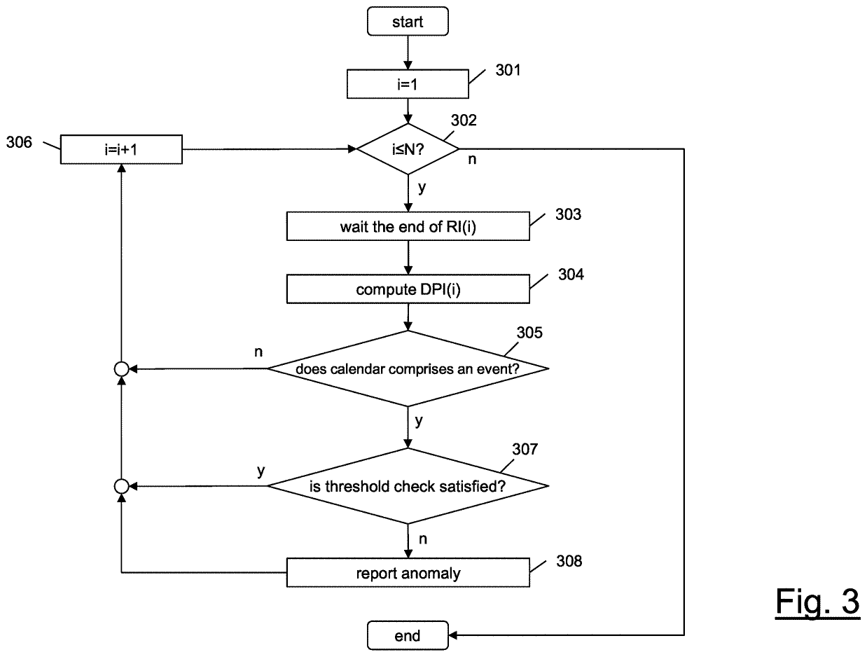

The method of the present invention will be now described in more detail with reference to FIGS. 2 and 3. In particular, FIG. 2 shows the values of a performance indicator (black line) of the data traffic during a specific event and corresponding differential values (grey line) of the same performance indicator. FIG. 3 is a flowchart illustrating the steps of the method for monitoring the data traffic during a target event according to the present invention.

Aspects of the method of the present invention preferably comprise three different stages.

A first stage of the method preferably comprises determining a monitoring profile to be applied for monitoring the data traffic associated with the provisioning of the considered service in relation to a given class of events related to certain statistically exceptional events. The monitoring profile comprises, for each considered performance indicator, one or more thresholds and corresponding rules to check whether the differential value of the performance indicator complies with or deviates from the thresholds.

For sake of non-limiting example, in the following description, it will be assumed that the considered service is a streaming media service and that the target event is a football match. It will also be assumed, for sake of non-limiting example, that a single performance indicator KPI is used to monitor the data traffic associated with the target event. The performance indicator KPI that will be considered herein after is a ratio between the downlink data traffic for the considered service and the overall data traffic handled by the packet data gateway 21.

The threshold profile for a football match provisioned by a streaming media service may be determined by firstly performing an analysis of historic data of performance indicators collected by the network nodes 21 of the core network 20 and related to a number of previous events of the same class of events to which the target event belongs, which are considered as sample events.

As an example, FIG. 2 shows the measured performance indicator KPI (black line) of the data traffic during a football match of the Italian football championship 2020/2021 and the corresponding differential value DPI (grey line). The football match starts at 20:45 and ends at 22:30. The performance indicator KPI is the ratio mentioned above. The horizontal axis reports the time of the day and is subdivided into the recording intervals RI of the football match, the primary vertical axis (on the left) reports the value of the considered performance indicator KPI and the secondary vertical axis (on the right) reports the differential value DPI of the considered performance indicator.

Aspects of the method of the present invention comprise providing a data traffic forecast associated with the class of events to which the considered target event belongs, which may be based on an outcome of the analysis of historic data mentioned above. For the considered target event, the moments which may cause a greater or lesser interest by the user in the target event are estimated and consequently the expected trends. In general, a forecast for the data traffic can be provided as follows:
the moments of greatest interest within the target event are associated with a growth in the data traffic especially if they temporally follow moments of minor or low interest (e.g., the start of a football match, the arrival in a cycling race, the beginning of a speech, etc.);
the moments of high interest that temporally follow moments of similar interest are associated with an almost constant data traffic forecast (e.g., in a football match the period of time that goes from the second quarter of an hour to the end of the first half of the match, the final part of a speech, etc.);
moments of low interest or moments which, despite being of high interest, temporally follow moments of higher interest, are associated with a decrease in the data traffic (e.g., the interval between the two halves of a football match, the period immediately following the end of the game, etc.).

An exemplary forecast for a football match (such as the football match represented by the data of FIG. 2) may be the following:
the data traffic is growing starting from 30 minutes before the start of the match and up to 30 minutes after the start of the match;
the data traffic is substantially stable for the next 15 minutes, namely until the end of the first half of the match;
the data traffic is decreasing during the interval between the two half times;
the data traffic is growing during the first 15 minutes of the second half;
the data traffic is substantially stable for the next 30 minutes, namely until the end of the second half of the match;
the data traffic slightly decreases starting from the end of the second half for the next 15 minutes;
the data traffic decreases for the next 30 minutes.

When the forecast is determined, the method provides for determining a related monitoring profile for the performance indicator(s) to be used for monitoring the data traffic.

Firstly, the duration of the target period TP is defined based on the effective duration of the target event and on the forecast. For a football match, which, as known, has a duration of 90 minutes, the target period TP may be set to, for instance, 150 minutes (comprising, as described above, 30 minutes before the start of the match, the duration of the match, the duration of the interval and 15 minutes after the end of the match).

The target period TP is then preferably subdivided into a number of target subperiods covering the considered event and each comprising a number of recording intervals RI. Each target subperiod is preferably associated with a specific identifiable trend of the measurements of the considered performance indicator KPI or in data derived therefrom. Identification of the specific trends is based on the data traffic forecast. In particular, according to embodiments of the present invention, each target subperiod is preferably selected as a time interval during which the data traffic is expected to grow or to remain substantially stable or to decrease, according to the forecast. Hence, three types of target subperiods are defined according to the expected behaviour of the data traffic (growing, remaining substantially stable, decreasing). According to these embodiments, for each type of target subperiod, a respective subset of thresholds for the differential value of the considered performance indicator KPI are preferably defined, to be applied in each recording interval RI comprised within the target subperiod.

In the following description, a current recording interval RI within the observation period OP will be indicated with the notation RI(i) and a previous adjacent recording interval will be indicated with the notation RI(i−1), where i=1, . . . , N is an integer counter of the recording intervals RI within the observation period OP and N is the number of recording intervals RI comprised in the observation period OP. The performance indicator measurement or value at the end of the current recording interval RI(i) will be indicated as KPI(i), where i=1, . . . , N. The differential value of the performance indicator at the current recording interval RI(i) will be indicated as DPI(i), where i=1, . . . , N; it is computed as the difference between the value of the considered performance indicator KPI(i) at the end of the current recording interval RI(i) and the value of the performance indicator KPI(i−1) at the end of the previous adjacent recording interval RI(i−1). It is to be noted that according to other embodiments of the method of the present invention, the differential value of the performance indicator KPI may be computed as the difference between the value of the considered performance indicator KPI(i) at the end of the current recording interval RI(i) and the value of the performance indicator at the end of a previous recording interval which may not be the previous adjacent recording interval.

A monitoring profile for the considered performance indicator KPI may then be defined as follows:
for each recording interval RI(i), where i=1, . . . , N:
   if the recording interval RI(i) belongs to a target subperiod where the data traffic is expected to increase (corresponding to a condition in which the differential value DP(i) is higher than zero), set a threshold Tg higher than zero and check whether the differential value DP(i) is higher than the threshold Tg, namely whether DP(i)>Tg;
   if the recording interval RI(i) belongs to a target subperiod where the data traffic is expected to remain substantially stable, set a first threshold Ts1 higher than zero and a second threshold Ts2 lower than zero, where preferably |Ts1|=|Ts2|, where |·|indicates the absolute value, and check whether the differential value DPI(i) is lower than the first threshold Ts1, i.e., whether DP(i)<Ts1, in case of a positive differential value DP(i), namely in case DPI(i)>0, and whether the differential value is higher than the second threshold, i.e., whether DP(i)>Ts2, in case the differential value DP(i) is negative, namely in case DP(i)<0;
   if the recording interval RI(i) belongs to a target subperiod where the data traffic is expected to decrease (corresponding to a condition in which the differential value DP(i) is lower than zero), set a further threshold Td lower than zero and check whether the differential value DP(i) is higher than the threshold Td, namely whether DP(i)>Td.

It may be noticed that, according to the monitoring profile described herein above, in a recording interval belonging to a target subperiod where the data traffic is expected to increase, an anomaly is detected in case the data traffic increase is below the related threshold, while in a recording interval belonging to a target subperiod where the data traffic is expected to decrease, an anomaly is detected in case the data traffic decrease is, in absolute value, above the related threshold. Indeed, the considered performance indicator is related to the data traffic actually handled by the network. In this case, any increase in the data traffic is not indicating a critical situation, even in case it is a huge increase. For the network operator, the data traffic which the network is actually able to handle represents a value. The monitoring profile would be different in case of a performance indicator related to a data traffic which is offered in the telecommunications network (which, as already anticipated above, represents a data traffic only possibly manageable by the network), or for other similar indicators (e.g., calls or sessions offered, BHCA or Busy-hour-call-attempts, etc.), whose increase may represent a critical situation. In this case, the system of the present invention may be configured with appropriate thresholds to detect an anomaly and possibly to trigger a management action for the resolution of the detected anomaly.

The value of the thresholds Tg, Ts1, Ts2, Td may be selected on the basis of the historic data mentioned above as related to sample events and/or on the basis of business/marketing models providing indications on the potential interest of users in a given target event and then on the expected audience of the target event.

An exemplary monitoring profile for monitoring the data traffic during a football match is defined herein below.

The monitoring profile may be defined as follows:
a data traffic growth is expected starting from 30 minutes before the start of the match and up to 30 minutes after the start of the match (first target subperiod): the threshold Tg to be applied in each recording intervals RI belonging to the first target subperiod is equal to +10%, i.e., the value of the considered performance indicator KPI(i) at the end of the current recording interval RI(i) should be at least 10% higher than the value of the considered performance indicator KPI(i−1) at the end of the previous recording interval RI(i−1);
it is expected that the data traffic remains substantially stable in the next 15 minutes, namely until the end of the first half of the match (second target subperiod): a subset of thresholds is to be applied in the recording intervals RI belonging to the second target subperiod, where the subset comprises a first threshold Ts1 equal to +20% and a second threshold Ts2 equal to −20%; in this case, the value of the considered performance indicator KPI(i) at the end of the current recording interval RI(i) should not deviate from the value of the considered performance indicator KPI(i−1) at the end of the previous recording interval RI(i−1) for an amount higher than 20% in absolute value;
a data traffic decrease is expected during the interval between the two half-times (third target subperiod): the threshold Td to be applied in the recording intervals RI belonging to the third target subperiod is equal to-40%; i.e., the value of the considered performance indicator KPI(i) at the end of the recording interval RI(i) should not be more than 40% lower than the value of the considered performance indicator KPI(i-1) at the end of the previous recording interval RI(i-1);
a data traffic growth is expected during the first 15 minutes of the second half (fourth target subperiod): the threshold Tg to be applied in the recording intervals RI belonging to the fourth target subperiod is equal to +10%; i.e., the value of the considered performance indicator KPI(i) at the end of the current recording interval RI(i) should be at least 10% higher than the value of the considered performance indicator KPI(i−1) at the end of the previous recording interval RI(i−1);
it is expected that the data traffic remains substantially stable in the next 30 minutes, namely until the end of the second half of the match (fifth time subperiod): a subset of thresholds is to be applied in the recording intervals RI belonging to the fifth target subperiod, where the subset comprises a first threshold Ts1 equal to +20% and a second threshold Ts2 equal to −20%; in this case, the value of the considered performance indicator KPI(i) at the end of the current recording interval RI(i) should not deviate from the value of the considered performance indicator KPI(i−1) at the end of the previous recording interval RI(i−1) for an amount higher than 20% in absolute value;
a data traffic slight decrease is expected starting from the end of the second half for the next 15 minutes (sixth target subperiod): the threshold Td to be applied in the recording intervals RI belonging to the sixth target subperiod is equal to 30%; i.e., the value of the considered performance indicator KPI(i) at the end of the current recording interval RI(i) should not be more than 30% lower than the value of the considered performance indicator KPI(i−1) at the end of the previous recording interval RI(i−1).

The skilled person will appreciate that the numerical values of the thresholds Tg, Ts1, Ts2, Td reported herein above are merely exemplary.

The second stage of the method of the present invention preferably comprises configuring the control system to perform the operation of data traffic monitoring associated with target events of the given class of events for which the monitoring profile has been determined.

Once determined, the monitoring profile is preferably stored in a database of the control system as associated to the related class of events, to be used at each occurrence of a target event belonging to the considered class (i.e., according to the exemplary scenario considered so far, each time the streaming media service carries the audio-video content of a football match to the service subscribers).

At this stage, the control system is preferably configured to schedule a target event of the given class of events in the calendar and associate with it the monitoring profile that has been determined at the first stage. In particular, preferably, ahead of the occurrence of the target event, an operator of the service provider accesses the control system and schedules the target event in the calendar. This means that the operator configures the calendar of the control system to schedule a target event for a given date and starting on a given time of the day. This scheduling operation may also be performed automatically in case the control system is provided with a catalogue of the events in advance.

Once the target event is scheduled in the control system calendar, the control system adds to the calendar an instance of the class-related monitoring profile, at the given date and time of the day of the respective target event. In other words, once the operator has scheduled the target event in the calendar, the control system preferably retrieves from the database the monitoring profile associated with the related class of target events and associates this monitoring profile with the scheduled target event to use the corresponding set of thresholds at the given date and time of the day of the target event. Preferably, the control system then adds a further instance of the same monitoring profile for each further occurrence of a target event of the same class that will be scheduled in the calendar.

The third stage of the method of the present invention preferably comprises detecting a time of start of the target event and, at the start of the target event, applying the monitoring profile to monitor the data traffic during the target event. The flowchart of FIG. 3 represents the operation of the control system according to this third stage of the method of the present invention for an observation period OP of operation of the control system comprising a target period TP associated with the target event. In particular, it is assumed that the observation period OP comprises an occurrence of a football match. For a target period TP of 150 minutes, the duration of the observation period OP may be selected to be 195 minutes as represented in FIG. 2. The skilled person will appreciate that these values of the duration of the target period and the observation period are merely exemplary.

It is to be noticed that the flowchart of FIG. 3 illustrates the operation of the control system for a limited duration in time corresponding to the observation period OP as defined above. However, the control system according to the present invention may be configured to cyclically repeat the steps of the flowchart of FIG. 3 in order to dynamically monitor the data traffic of the considered service to follow the data traffic fluctuations occurring at statistically exceptional events belonging to a same class, as it will be clearer from the following description. In this way, the method of the present invention allows to dynamically monitor the data traffic fluctuations associated with, for instance, the streaming of football matches.

The functioning of the control system comprises collecting the measured value of the considered performance indicator KPI cyclically with a repetition period equal to the recording interval RI and storing each measured value in a database.

Moreover, when the control system starts its operation in the considered observation period OP (steps 301 and 302), it preferably implements a series of operations which are repeated cyclically with a repetition period equal to the recording interval RI. In particular, at each recording interval RI(i), 1=1, . . . , N, of the observation period OP, the control system preferably waits the end of the recording interval RI(i) to collect the measurement of the performance indicator KPI(i), which is also stored in the database (step 303). Then, at step 304, the control system preferably computes the difference DP(i) between the measured value of the performance indicator KPI(i) and the measured value of the performance indicator KPI(i−1) collected at the end of the previous recording interval RI(i−1) and stored in the database.

At step 305, the control system preferably checks whether its calendar, at the current recording interval RI(i), comprises an instance of the monitoring profile associated with a football match (which corresponds to checking whether the current recording interval RI(i) belongs to the target period TP of the target event). If the calendar does not comprise such instance, the control system skips (step 306) to the next recording interval RI(i+1) to repeat steps 303 and 304, until the end of the observation period OP (step 302).

If the calendar comprises the instance of the monitoring profile in the current recording interval RI(i), the control system preferably checks whether the differential value DP(i) of the performance indicator KPI complies with the threshold(s) to be applied in the current recording interval RI(i) according to the considered monitoring profile (step 307). If the differential value DP(i) of the performance indicator complies with the threshold(s), the control system skips (step 306) to the next recording interval RI(i+1) to repeats steps 303-307. If the differential value DP(i) of the performance indicator deviates from the threshold(s), the control system preferably reports an anomaly (step 308) to the performance management system or to the fault management system, as already mentioned above, and then skips (step 306) to the next recording interval RI(i+1) to repeats steps 303-307.

It is to be noticed that according to the flowchart of FIG. 3, the control system is not applying any monitoring profile for the data traffic monitoring in the recording intervals that do not belong to the target period TP, according to the check that is performed at step 305. However, in the recording intervals RI of the observation period OP which do not belong to the target period TP, the control system may be configured to apply a “standard” monitoring profile, namely a monitoring profile that is not associated whit any class of statistically exceptional events but may be associated instead whit an expected “normal” functioning of the telecommunications network (namely, to a functioning of the telecommunications network in a day which does not comprise any statistically exceptional event). The standard monitoring profile may be a static monitoring profile containing one or more thresholds statically predefined to follow the expected trend of the data traffic during the day.

When, for example, the operations of the flowchart of FIG. 3 are applied to the data traffic associated with the football match described in relation with FIG. 2, the following considerations may be made.

As reported in FIG. 2, the target period TP of the considered football match spans over ten recording intervals RI. According to the forecast described above, recording intervals from RI(1) to RI(4) belongs to the first target subperiod where the data traffic is expected to grow. The differential values DP(1) to DP(4) of the considered performance indicator KPI are, respectively, +6%, +36%, +91%, +33%. In this case, the check performed by the control system at step 307 at the end of the first recording interval RI(1) determines that the differential value DP(1) of the performance indicator KPI deviates from the threshold Tg, which is +10%. In this case, an anomaly is detected and reported, which indicates that the data traffic is increasing slower than expected. The differential values DP(2)−DP(4) of the performance indicator KPI computed at the end of the subsequent recording intervals RI(2)−RI84) instead all comply with the threshold.

The recording interval RI(5) belongs to the second target subperiod; the differential value DP(5) of the performance indicator KPI is +2%, which is compliant with the first threshold Ts1 to be applied during the second target subperiod, i.e. +20%.

The recording interval RI(6) belongs to the third target subperiod; the differential value DP(6) of the performance indicator KPI is −6%, which is compliant with the threshold Td to be applied in the third subperiod, i.e. −40%.

The recording interval RI(7) belongs to the fourth target subperiod, and the differential value DP(7) of the performance indicator KPI is +22%, which is compliant with the threshold Tg to be applied in the fourth subperiod, i.e. +10%.

The recording intervals RI(8) and RI(9) belong to the fifth target subperiod. The differential values DP(8) and DP(9) of the performance indicator KPI are, respectively, +13% and +1%. These values are compliant with, respectively, the first threshold Ts1 and the second threshold Ts2 to be applied in the fifth target subperiod, i.e., +20% and −20%.

The recording interval RI(10) belongs to the sixth target subperiod and the differential value DP(10) of the performance indicator KPI is −48%, which deviates from the threshold Td to be applied in the sixth subperiod, i.e. −30%. In this case an anomaly is detected and reported as the data traffic is decreasing faster than expected.

As apparent from the above description, the method of the present invention allows to effectively monitor the data traffic associated with the target event. The method described above advantageously allows to detect, and eventually manage, possible failures potentially causing a degradation in the quality of service and then in the quality of experience perceived by the users of the provisioned service in presence of the data traffic fluctuations correlated with the target event. Indeed, the method is based on a dynamic application of a monitoring profile which is determined to follow the trend of the data traffic when the target event of a given class of events occurs, which comprises computing the differential value of the performance indicator on a recording interval basis, which closely indicate the data traffic fluctuations, and comparing such differential values with a set of suitable thresholds that allow to detect when the data traffic deviates from the expected one.

1. A method for monitoring a data traffic in a telecommunications network, said data traffic being associated with a service providing a multimedia content to users via at least one network node the multimedia content being associated with a target event, the method comprising applying a monitoring profile to monitor said data traffic in a target period comprising said target event, the target period being subdivided into discrete recording intervals (RI, RI(i)), said monitoring profile comprising a set of thresholds to be applied to process measurements of a performance indicator at said recording intervals wherein applying said monitoring profile comprises, at each of said recording intervals:
a) collecting measurements of the performance indicator provided by said at least one network node;
b) computing a differential value (DP(i)) of said performance indicator as a difference between a current measurement of said performance indicator measured at said each of said recording intervals (RI(i)) and a previous measurement of said performance indicator measured at a previous recording interval (RI(i−1));
c) comparing said differential value (DP(i)) with one or more respective thresholds of said set of thresholds; and
d) if said differential value (DP(i)) does not comply with said one or more thresholds, detecting an anomaly in the data traffic.

2. The method according to claim 1, wherein said monitoring profile is associated with a class of events to which the target event belongs.

3. The method according to claim 2, wherein it further comprises determining said monitoring profile on the basis of a data traffic forecast for the data traffic associated with said class of events.

4. The method according to claim 3, wherein said determining said monitoring profile further comprises subdividing said target period into a number of target subperiods, wherein each of said target subperiods comprises a respective number of recording intervals (RI, RI(i)) and each target subperiod is associated with a respective specific trend in the measurements of said performance indicator, said specific trends being identified according to said data traffic forecast.

5. The method according to claim 4, wherein each target subperiod is selected as a time interval during which the data traffic is expected to grow or to remain substantially stable or to decrease.

6. The method according to claim 5, wherein said monitoring profile is defined as follows:
for each recording interval RI(i), where i=1, . . . , N, i being an integer number counting the recording intervals RI(i) within said target period:
if the recording interval RI(i) belongs to a target subperiod where the data traffic is expected to grow, set a threshold, higher than zero and check whether said differential value (DPI(i)) is higher than said threshold, Tg;
if the recording interval RI(i) belongs to a target subperiod where the data traffic is expected to remain substantially stable, set a first threshold, higher than zero and a second threshold, lower than zero, and check whether said differential value (DPI(i)) is lower than said first threshold, in case said differential value is higher than zero, and whether said differential value is higher than said second threshold, in case said differential value (DP(i)) is lower than zero; or
if the recording interval RI(i) belongs to a target subperiod where the data traffic is expected to decrease, set a further threshold, lower than zero and check whether said differential value (DP(i)) is higher than said further threshold.

7. The method according to claim 2, wherein said monitoring profile is stored in a database as associated with said class of events.

8. The method according to claim 7, wherein if further comprises scheduling said target event in a calendar at a given date and time of the day and adding to said calendar an instance of said monitoring profile at said given date and time of the day to monitor said data traffic associated with the target event according to said monitoring profile.

9. The method according to claim 1, wherein said performance indicator is one of the following:
an amount of downlink or uplink data traffic associated with said service handled by said at least one network node,
an amount of downlink or uplink data traffic associated with said service handled by one of said at least one network node,
a data traffic throughput associated with said service,
a ratio between a downlink or uplink data traffic for said service and an overall downlink or uplink data traffic handled by one of said at least one network node.

10. The method according to claim 1, wherein said service is a streaming media service.

11. A method for managing a telecommunications network, the method comprising:
monitoring a data traffic in said telecommunications network according to the method of claim 1, said data traffic being associated with a service providing a multimedia content to users via at least one network node of said telecommunications network, the multimedia content being associated with a target event, and
managing network resources of said telecommunications network to react to said detected anomaly.

12. A control system for monitoring a data traffic in a telecommunications network, said data traffic being associated with a service providing a multimedia content to users via at least one network node, the multimedia content being associated with a target event, the control system being configured to apply a monitoring profile to monitor said data traffic in a target period comprising said target event, the target period being subdivided into discrete recording intervals, said monitoring profile comprising a set of thresholds to be applied to process measurements of a performance indicator at said recording intervals, wherein the control system is further configured to, at each of said recording intervals:
collect measurements of the performance indicator provided by said at least one network node;
compute a differential value of said performance indicator as a difference between a current measurement of said performance indicator measured at said each of said recording intervals and a previous measurement of said performance indicator measured at a previous recording interval;
compare said differential value with one or more respective thresholds of said set of thresholds; and
if said differential value does not comply with said one or more thresholds, detect an anomaly in the data traffic.

13. A telecommunications network comprising at least one network node and a control system according to claim 12.
